(19) United States
(12) Patent Application Publication
(10) Pub. No.: US 2011/0025720 A1
(43) Pub. Date: Feb. 3, 2011

(54) DATA SCROLL METHOD AND APPARATUS

(75) Inventors: Sun-Haeng Jo, Suwon-si (KR); Seong-Hoon Kang, Suwon-si (KR); Hye-Soo Lee, Seoul (KR); Ji-Young Kim, Suwon-si (KR); Won-Young Choi, Suwon-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/840,720

(22) Filed: Jul. 21, 2010

(30) Foreign Application Priority Data
Jul. 28, 2009 (KR) 10-2009-0069011

(51) Int. Cl. G09G 5/00; G06F 3/041

(52) U.S. Cl. 345/684; 345/173

(57) ABSTRACT

Disclosed is a method and apparatus for scrolling data displayed on a screen, dividing a display region as a multiple of predefined weighted areas and setting a scroll velocity weight corresponding to each of the multiple of weighted areas when there is scrollable undisplayed data, after displaying data on the display region corresponding to execution of an application. Scroll velocity weight is detected corresponding to the initially produced point of the scroll input when a scroll input is sensed t, and an actual movement distance is detected corresponding to the scroll input in real-time until the scroll input ends. A scroll movement distance is calculating in proportion to the detected scroll velocity weight and the actual movement distance, and the data is displayed by shifting the data in a proceeding direction of the scroll input by the calculated scroll movement distance.

### PRIORITY

This application claims the benefit under 35 U.S.C. §119(a) of an application entitled “Data Scroll Method and Apparatus” filed in the Korean Industrial Property Office on Jul. 28, 2009 and assigned Serial No. 10-2009-0069011, the contents of which are incorporated herein by reference.

### BACKGROUND OF THE INVENTION

1. Field of the Invention

The present invention relates to the data display of an electronic apparatus, and more particularly relates to a method and apparatus of scrolling data displayed on the screen.

2. Description of the Related Art

In general, a “scroll” moves displayed contents on a screen up, down, left and right, and refers to an action of shifting all of the previously displayed contents upward, downward, to the left and to the right in a continuous manner when the amount of information to be displayed on the screen exceeds the capacity of the screen. For example, the upward scrolling means displaying a new data at the bottom line of the screen and deleting the top line by moving the entire data displayed on the current screen upward. Such a scrolling is employed that a user can retrieve undisplayed data when the volume of a normally displayed entire data is greater than a volume displayed by a corresponding apparatus at one time or on one screen.

Meanwhile, new mobile terminals such as portable phones, PDAs and laptop computers tend to gradually shrink in both size and weight. Also, for miniaturization and weight reduction of the mobile terminals, recently mobile terminals equipped with a touch screen have emerged in place of a keypad. In this mobile terminal, a keypad part having a multiple of hardware keys was removed and the touch-screen that the user can touch in direct ways to input a key is provided as a display part. For mobile terminals equipped with a touch-screen, data is scrolled and displayed through the touch-screen according to a user's input.

However, because a smaller mobile terminal leads to a smaller screen size, it is often impossible to display all data on one screen. In this case, it is necessary to check undisplayed data through a screen scroll. However, due to the small screen size, confirming all data inconveniences a user since the user must perform the scroll operation several times.

For example, when there is a scroll input in a touch-screen equipped mobile terminal, displayed data will shift in a movement amount in fixed-ratio proportion to a distance an input means, for example a finger or a stylus pen, on the touch-screen. For that reason, the user must repeatedly perform a scroll touch input in order to search for wanted data and confirm data input.

### SUMMARY OF THE INVENTION

Accordingly, the present invention is directed to a screen scroll method and apparatus that allows a user to confirm data conveniently and in a speedy way.

In accordance with an aspect of the present invention, a terminal having a screen for displaying data and an input means capable of a scroll input of data displayed on the screen is provided, and includes dividing a display region as a multiple of predefined weighted areas and setting a scroll velocity weight corresponding to each of the multiple of weighted areas when there is a scrollable undisplayed data, after a data is displayed on the display region corresponding to any application according to the execution of any application; detecting a scroll velocity weight corresponding to the initially produced point of the scroll input when a scroll input is sensed through the input means; and detecting an actual movement distance corresponding to the scroll input in real-time until the scroll input ends, calculating a scroll movement distance in proportion to the detected scroll velocity weight and the actual movement distance and displaying the data by shifting the data in the proceeding direction of the scroll input by the calculated scroll movement distance.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram of a portable terminal according to one embodiment of the present invention;

FIG. 2 is a flowchart of the operation of a portable terminal according to an embodiment of the present invention;

FIG. 3 shows a display procedure according to one embodiment of the present invention; and

FIGS. 4A through 4e show a display procedure according to another embodiment of the present invention.

### DETAILED DESCRIPTION OF THE PREFERRED EMBODIMENTS

Hereinafter, exemplary embodiments of the present invention will be described in detail with reference to the accompanying drawings. Further, in the following description of the present invention, a detailed description of known functions and components incorporated herein will be omitted when it may make the subject matter of the present invention rather unclear.

The present invention provides a scroll method to confirm all data more speedily with less manipulation by a user when the amount of data to be provided on a screen at one time exceeds a quantity displayable on the screen or a on the corresponding application window. Therefore, when in an over-size display state in which the amount of data to be provided in the current stage according to any application execution exceeds a displayable quantity, a terminal of this invention displays a default screen of data. Then, the terminal divides a display region as a multiple of weighted areas and sets a different scroll velocity weight to each divided weighted area. Thereafter, when a scroll input is sensed, a scroll velocity weight corresponding to an initially input position is detected and a scroll velocity is set according to the detected scroll velocity weight. Then, the movement direction and actual movement distance of the scroll input are detected in real-time, a scroll movement distance is calculated using the actual movement distance and the scroll moving velocity, and data is displayed by shifting the data in the movement direction by the adjusted scroll movement distance.

At this time, even if a scroll input, when in the process of a continuing scroll input, is detected at other weighted areas departing from the initial scroll input sensed weighted area, the scroll velocity weight that was set according to the initial scroll input is not changed. Then, if a finger panning occurs, as in the case of a touch-screen equipped terminal, a data scroll is performed in a finger panning-occurring direction for display while a predefined scroll velocity weight is maintained.

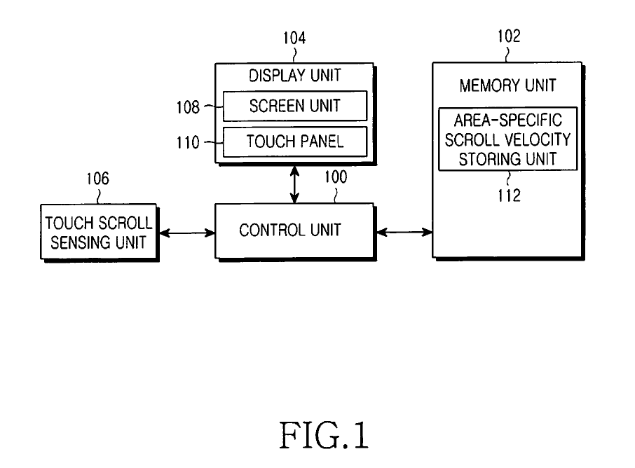

One example of the construction of a portable terminal applying the present invention is shown in FIG. 1, which is a block diagram of a portable terminal equipped with a touch-screen according to one embodiment of the present invention. Referring to FIG. 1, the portable terminal includes a control unit 100, and a memory unit 102, a display unit 104 and a touch scroll sensing unit 106, each connected to the control unit 100.

The display unit 104 includes a touch-screen, and thus it includes a screen unit 108 and a touch panel 110 constructing the touch-screen. The display unit 104 displays the status of the portable terminal 100 on the screen unit 108. Screen unit 108 is preferably realized as an LCD (Liquid Crystal Display), with a memory capable of storing displayed data.

The touch panel 110 overlays the LCD of the screen unit 108 so that a user can confirm data displayed on the screen unit 108 and simultaneously perform a touch input. In addition, the touch panel 110 has a touch sensing unit and a signal conversion unit. The touch sensing unit senses the control command of a touch such as a touch, drag, drop, etc. from the change in physical quantities, for example resistance, capacitance or the like. Also, the signal conversion unit converts the change in physical quantity into a touch signal and outputs the signal to the touch scroll sensing unit 106 and the control unit 100.

The touch scroll sensing unit 106 determines if the input of the touch panel 110 is an input for a touch scroll based on the control of the control unit 100. For example, the touch scroll sensing unit 106 in a preferred embodiment is constructed from a timer. When a touch input is sensed from the touch panel 110, the control unit 100 can apply the touch input to the touch scroll sensing unit 106 to determine if the touch input is an input for scroll, according to whether the touch input of a user is maintained at the same position during at least a given preset time.

Another example of a scroll input may be determined as a separate input indicating a scroll input. For example, a special scroll key input and the following touch and drag input produced in a display region may be decided as the scroll input.

In another way, a scroll input using an input device such as a mouse may be provided.

The memory unit 102 stores a program for the processing and control of the control unit 100, a reference data, each kind of renewable, preservable data, etc., and is provided as a working memory of the control unit 100. Also, the memory unit 102 includes partition information for a display region for forming a multiple of weighted areas and an area-specific scroll velocity storing unit 112 for storing a scroll velocity corresponding to each of the multiple of weighted areas, according to one embodiment of the present invention.

The control unit 100 performs voice signal and data processing, and controls each part of a portable terminal according to protocols for telephone calling, data communication or wireless Internet access. Also, the control unit 100 divides and sets a multiple of weighted areas of the display region, controls the setting of a scroll velocity corresponding to each weighted area and controls the display unit 104 so that data is scrolled and displayed with a corresponding scroll velocity based on a touch scroll input occurring point according to one embodiment of the present invention.

In other words, the control unit 100 controls a screen output including a portion of data to be displayed on the screen unit 108, when in an over-size display state that a data amount to be provided in the current state is greater than a displayable amount according to an application execution. Then, the control unit 100 divides the display region as a multiple of predefined weighted areas and sets a different scroll velocity weight to each divided weighted area. Herein, the display region may be the entire screen according to a type of running application and the display region may be an application window of a certain size. The position or size of the multiple of predefined weighted areas according to the display region, a scroll velocity corresponding to each weighted area, etc. may be a default value corresponding to the form of a display region or the type of an executed application, as set by a user.

The setting function of a weighted area and a weighting velocity by a user can be provided through a specific menu. For example, a multiple scroll velocity setting menu can be provided, and the multiple scroll velocity setting menu preferably have sub menus of weighted area setting and scroll velocity setting. Therefore, when a user selects the multiple velocity weight setting menu, the control unit 100 provides sub menus for weighted area setting and scroll velocity weight setting through the display unit 104. When the user selects the weighted area setting sub-menu, the control unit 100 provides a region frame corresponding to the display region. The user can divide the display region as a multiple of areas through a touch input or the like, and the control unit 100 stores a piece of region information divided by the user in the area-specific scroll velocity storing unit 112 as weighted area information.

A scroll velocity for each weighted area divided by a user may be set as a default value or may be set by the user. When the user selects the scroll velocity weight setting sub-menu, the control unit 100 provides each weighted area according to a multiple of stored weighted area information visually through the display unit 104. That is, portions are exhibited where a multiple of weighted areas are placed in the entire display region. The user confirms the position of the displayed weighted area, and a weighting value corresponding to each weighted area can be input numerically. The control unit 100 sets and stores an inputted numeric value as the scroll velocity weight of a corresponding weighted area.

After the described setting procedure is terminated, and when a scroll input is sensed through the touch panel 104, the control unit 100 confirms a weighted area corresponding to an initial input position and detects a scroll velocity weight corresponding to the same weighted area. Then, the control unit 100 sets a scroll velocity according to the detected scroll velocity weight. Thereafter, the display unit 104 is controlled such that the movement direction of a user-originated scroll input and the actual movement distance on the touch panel 108 are detected in real-time, and a scroll movement distance is calculated using the actual movement distance and the scroll moving velocity, and data is displayed by shifting the data in the moving direction by the calculated scroll movement distance.

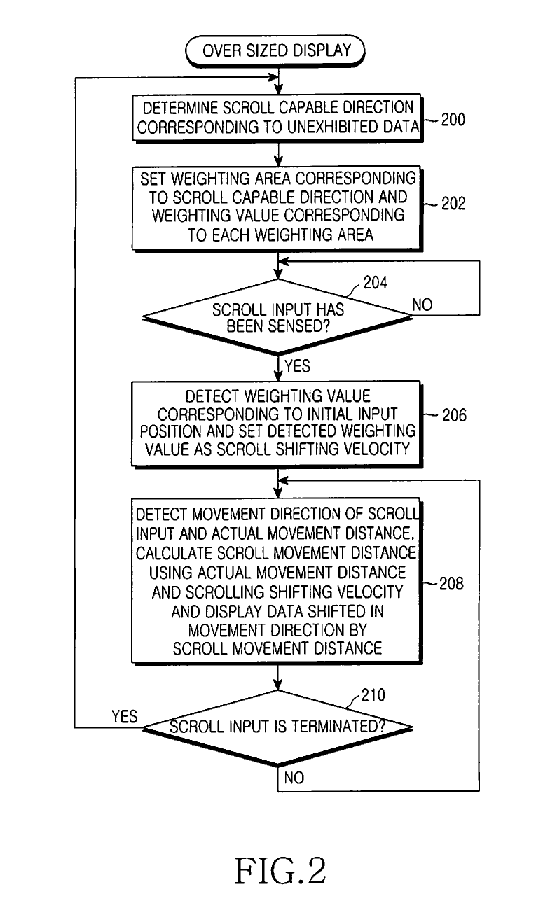

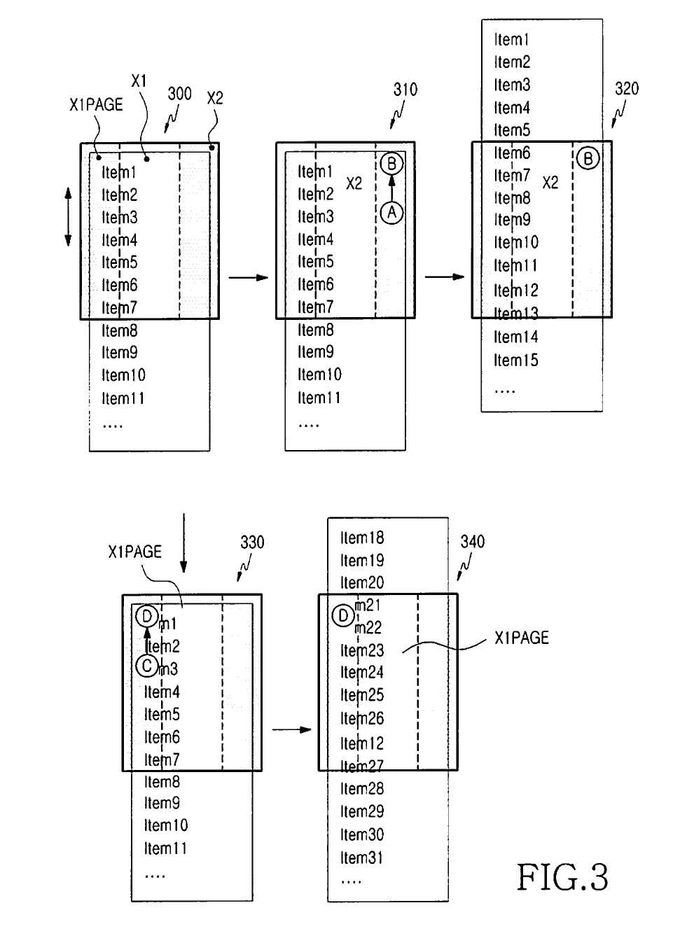

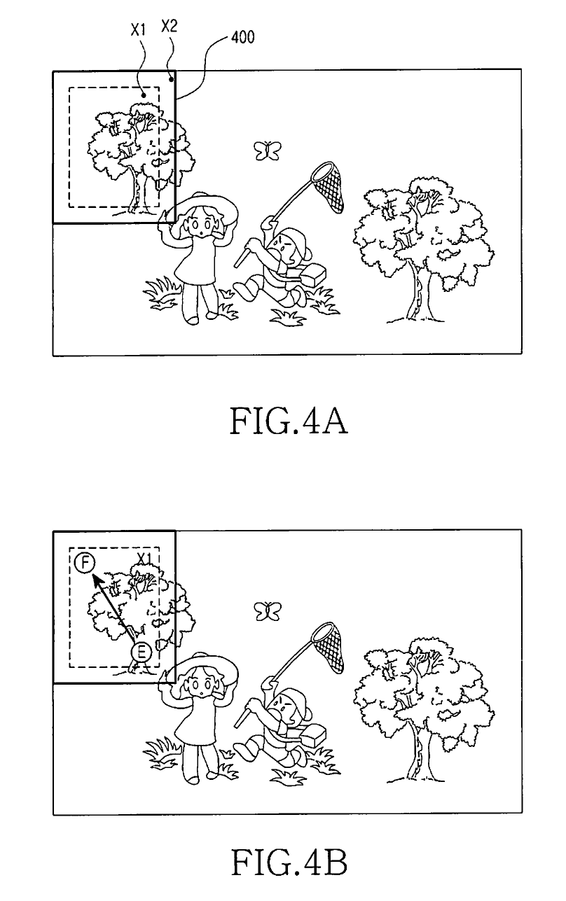

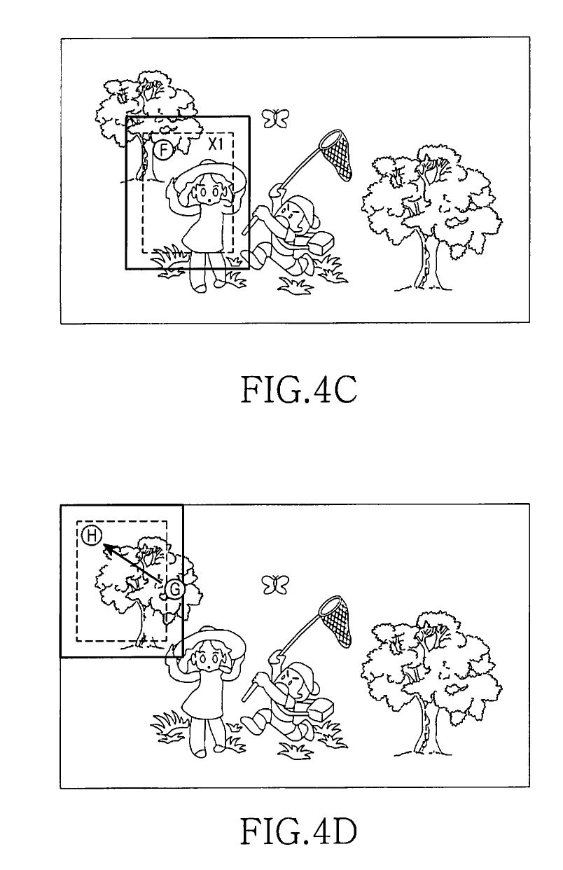

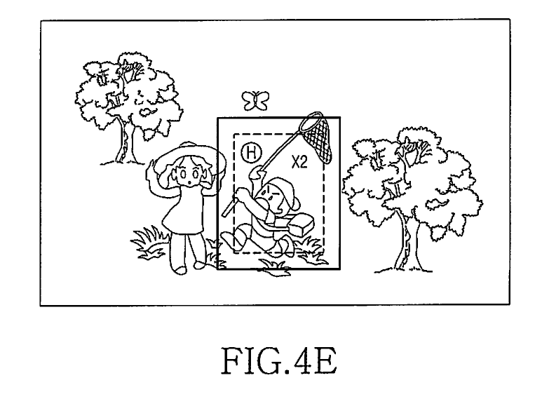

Operation of the constructed portable terminal is shown in FIG. 2. Referring to FIG. 2, the control unit 100 of the portable terminal displays a default screen including a part of data to be provided on the screen unit 108, when in an over-sized display state that a data amount to be provided in the current stage is greater than a displayable amount according to any application execution. Such examples are shown in FIG. 3 and FIG. 4A through 4E.

FIG. 3 indicates application of this invention when the length of a list is not fully displayed on one screen, when the corresponding list is displayed according to an application execution. Following, FIGS. 4A through 4E indicate an application of this invention when an image is not fully displayed on one screen, but when the image is to be displayed.

In FIG. 3, a display region for a list is the entire screen, and seven items can be displayed one time on the entire screen. Therefore, the portable terminal displays the screen 300 containing seven items as an initial screen.

In FIG. 4A, a display region for an image is the entire screen, and the portion displayable at one time on the entire screen is only a part of the image. Therefore, a screen 400 containing a part of the image is displayed as FIG. 4A.

In step 200 of FIG. 2, the portable terminal recognizes an over-sized display state, and determines a scroll capable direction equivalent to undisplayed data. That is, in step 200, the portable terminal determines the direction that requires further display of the undisplayed data, from among the up, down, left and right directions.

Since the example of FIG. 3 corresponds to a case in which a list is displayed, the scroll capable direction equivalent to an undisplayed data will be the up/down direction with respect to the screen. As shown in FIG. 4A, when an image of a larger size is displayed, a scroll capable direction equivalent to the undisplayed data is either the left/right direction or the up/down direction with respect to the screen.

After the control unit 100 determines a scroll capable direction in step 200, the control unit 100 proceeds to step 202 and sets a weighted area corresponding to the scroll capable direction and a scroll velocity weight corresponding to each weighted area. As the weighted area is set differentially based on the scroll capable direction, various weighted areas according to the scroll capable direction can be established.

Referring to the screen 300 in the example of FIG. 3, the display region, i.e. the entire screen, is divided into three weighted areas, and a scroll velocity weight corresponding to each weighted area is one page speed multiple (X1 page), one-speed multiple (X1) and two-speed multiples (X2), respectively.

In the example of FIG. 4A, one screen is divided into two weighted areas in a picture frame form, and a scroll velocity weight corresponding to each velocity weight is one speed multiple (X1) and two speed multiple (X2).

According to one embodiment of the present invention, one speed multiple is a speed weighting for calculating a screen movement distance identical to a distance of an input means, for example movement of a finger or a stylus pen, and other speeds are calculated based on the screen movement distance of the one speed multiple.

Continuing in the procedure of FIG. 2, the control unit 100 proceeds to step 206 when there is a scroll input sensed through the touch panel 110 in step 204. In step 206, the control unit 100 determines a weighted area corresponding to the initially produced position of the scroll input, detects a scroll velocity weight set based on the same weighted area and sets a scroll moving velocity corresponding to the detected scroll velocity weight.

For example, as shown in a screen 310 of FIG. 3, when a scroll input is sensed in point A, the control unit 100 detects a scroll velocity weight as a two-speed multiple and sets a corresponding scroll velocity. Also, the control unit 100 preferably displays “X2” indicating the two-speed multiple as scroll speed information while the scroll input is maintained.

Thereafter, in step 208, the control unit 100 detects the movement direction of a user-originated scroll input and the actual movement distance on the touch panel 110 in real-time, calculates a scroll movement distance using the actual movement distance and the scroll moving velocity and displays data by shifting the data in the movement direction by the calculated scroll movement distance.

For example, as shown in the screen 310 of FIG. 3, when a scroll input from point A to point B is sensed, the control unit 310 sets the two-speed multiple scroll speed and then detects an actual movement distance from point A to point B, that is an actual movement distance from item 3 to item 1 in real-time. Then, a scroll movement distance is calculated in proportion to 2 speed multiple setting and the change of the actual movement distance, and the screen is correspondingly shifted and displayed. Therefore, the final scroll movement distance is calculated to be from “Item 1” to “Item” 6, and items below “Item 6” are displayed as shown in the screen 320.

As shown in a screen 330 of FIG. 3, if a scroll input from point C to point D is sensed, the control unit 100 sets the one-page speed multiple scroll speed and then detects an actual movement distance from point C to point D, that is a distance from item 3 to item 1 as an actual movement distance. Then, a scroll movement distance is calculated in proportion to the one-page speed multiple setting and the change in the actual movement distance, and the screen is correspondingly shifted and displayed. Therefore, the final scroll movement distance is calculated to be a distance from “Item 1” to “Item 20”, and items below “Item 21” are displayed as shown in screen 340 of FIG. 3.

Because a list is displayed in the embodiment of FIG. 3, a touch input means such as a finger or a stylus pen on the touch panel 110 has a strong possibility to shift in upward/downward directions for a scroll input. However, if a scrollable data that moves in any one of upward/downward direction, left/right direction, etc. is displayed as shown in FIG. 4A, a touch input means can move in any one of upward/downward and left/right directions, etc. on the touch panel 110 freely for a scroll input, and thus an action such as a finger panning may occur. For that reason, the control unit 100 needs to determine the actual movement distance of a scroll input in real-time and also determine the moved distance of the scroll input as well. Then, the control unit 100 calculates a scroll movement distance using the actual movement distance and a scroll moving velocity and displays data by shifting the data in the movement direction by the calculated scroll movement distance.

In addition, a scroll velocity and movement distance calculation procedure set in the steps 206 and 208 is maintained until the continuity of a scroll input ends as shown in step 210 of FIG. 2.

For example, referring to FIGS. 4A through 4E, when a scroll input from point E to point F is sensed as shown in FIG. 4B in a state that a weighted area and a scroll velocity weight are set as shown in FIG. 4A, the control unit 100 sets the one-speed multiple scroll velocity and then detects an actual movement distance from point E to point F. Then, a scroll movement distance in proportion to the one-speed multiple scroll velocity and the change of the actual movement distance is calculated to be the same distance as the actual movement distance. An image is scrolled moving according to a scroll input proceeding direction and the center bottom part is displayed as shown in FIG. 4C. At this time, point E and point F are both placed in the one-speed multiple weighted area.

However, when a scroll input from point G in the two-speed multiple weighted area to point H in the one-speed multiple weighted area is sensed as shown in FIG. 4D, weighted areas of an initial scroll input point and a final scroll input point are each different areas. In this case, according to the present invention, a scroll velocity weight is not changed and the scroll velocity weight, that is the two-speed multiple, of the initial scroll point is maintained. In other words, the control unit 100 sets the two-speed multiple scroll speed corresponding to point G, and then detects an actual movement distance from point G to point H in real-time. Then, even if the path of a scroll input departs from a weighted area of the initial scroll input produced position, the scroll movement distance is calculated using the scroll velocity weight, that is the two-speed multiple, of the initial scroll input position. As a result, the rightmost bottom part of the image is displayed as shown in FIG. 4E.

Also, due to an input action such as a finger panning, even if a scroll direction is changed in a short time, a scroll speed set when the same scroll input is initially produced is also still maintained as long as the continuity of the scroll input is preserved.

As described above, when a scroll is needed according to the characteristic of an activated application because all data cannot be displayed at one time in a display region, such as a big sized image, e.g. a web browser and a telephone book, the present invention allows a speedy and precise screen scroll when needed by setting a multiple of scroll speeds.

The present invention can provide a scroll method and apparatus that confirms all data more speedily with less manipulation by a user and retrieves data the user desires quickly, when the amount of data to be displayed on a screen exceeds one screen's capacity.

While this specification has been described in regard to exemplary embodiments, several modifications can be implemented without departing from the scope of the present invention. For example, a display region may be an entire screen, or it may be a display window. In addition, a weighted area and a scroll velocity weight can be set corresponding to each kind of application. Also, while a scroll input in one example of the above embodiment is sensed through a touch panel, a scroll can be input through a mouse or a digitizer, etc. Thus, the present invention can be applied to any scroll input capable terminal that does not have a touch panel. Also, a data scroll apparatus according to the present invention may include a touch-screen and a control unit, wherein the control unit is configured to control that the size of a first data range scrolled according to a scroll input across a first length of a first region on the touch-screen is larger than the size of a second data range scrolled according to a scroll input across the first length of a second range, and that the size of a third data range scrolled according to a scroll input across the first length starting from the first region and ending at the second region is the same as the size of the first data range. Therefore, the scope of the present invention is not limited by the described embodiments but it should be defined by the appending claims and equivalents to the claims.

What is claimed is:

1. A data scroll method of a terminal, the terminal having a screen that displays data and an input means capable of a scroll input of data displayed on the screen, the method comprising the steps of
dividing a display region as a multiple of predefined weighted areas and setting a scroll velocity weight corresponding to each multiple of weighted areas when there is scrollable undisplayed data, after data is displayed on the display region corresponding to execution of an application;
detecting a scroll velocity weight corresponding to an initially produced point of the scroll input when a scroll input is sensed through the input means; and
detecting an actual movement distance corresponding to the scroll input in real-time until the scroll input ends, calculating a scroll movement distance in proportion to the detected scroll velocity weight and the actual movement distance and displaying the data by shifting the data in a proceeding direction of the scroll input by the calculated scroll movement distance.

2. The method of claim 1, wherein the detected scroll velocity weight is used for the scroll movement distance calculation until the scroll input ends.

3. The method of claim 2, wherein position and size of the multiple of weighted areas in the display region is determined according to a type of the application.

4. The method of claim 2, wherein position and size of the multiple of weighted areas in the display region is determined according to a form of the display region.

5. The method of claim 2, wherein position and size of the multiple of weighted areas in the display region is determined according to a scroll capable direction in the initial screen.

6. The method of claim 2, wherein the position and size of the multiple of weighted areas in the display region and a scroll velocity weight corresponding to each of the multiple of weighted areas are determined according to a user's input.

7. The method of claim 1, wherein the input means is a touch panel installed on an upper part of the screen to construct a touch screen.

8. The method of claim 7, wherein when a scroll input by a finger panning is produced on the touch panel, the method further comprising:
determining the actual movement distance by the finger panning and a scroll input proceeding direction in real-time, calculating a scroll moving distance in proportion to the actual movement distance and displaying the data by shifting the data in the proceeding direction by the calculated scroll moving distance.

9. A data scroll apparatus comprising:
a screen for displaying data;
an input device capable of a scroll input of data displayed on the screen; and
a control unit for, after displaying data on a display region corresponding to execution of an application, dividing the display region as a multiple of predefined weighted areas and setting a scroll velocity weight corresponding to each of a multiple of the weighted areas when there is scrollable undisplayed data, detecting a scroll velocity weight corresponding to an initially produced point of the scroll input when a scroll input is sensed through the input device, and detecting an actual movement distance corresponding to the scroll input in real-time until the scroll input ends, calculating a scroll movement distance in proportion to the detected scroll velocity weight and the actual movement distance and displaying the data by shifting the data in a proceeding direction of the scroll input by the calculated scroll movement distance.

10. The apparatus of claim 9, wherein the detected scroll velocity weight is used for the scroll movement distance calculation until the scroll input ends.

11. The apparatus of claim 10, wherein position and size of the multiple of weighted areas in the display region is determined according to a type of the any application.

12. The apparatus of claim 10, wherein position and size of the multiple of weighted areas in the display region is determined according to a form of the display region.

13. The apparatus of claim 10, wherein position and size of the multiple of weighted areas in the display region is determined according to a scroll capable direction in the initial screen.

14. The apparatus of claim 10, wherein position and size of the multiple of weighted areas in the display region and a scroll velocity weight corresponding to each of the multiple of weighted areas are determined according to a user's input.

15. The apparatus of claim 9, wherein the input device is a touch panel installed on an upper part of the screen to construct a touch screen.

16. The apparatus of claim 15, wherein when a scroll input by a finger panning is produced on the touch panel, the control unit determines the actual movement distance by the finger panning and a scroll input proceeding direction in real-time, calculates a scroll moving distance in proportion to the actual movement distance and displays the data by shifting the data in the proceeding direction by the calculated scroll moving distance.

17. A data scroll apparatus comprising:
a touch screen; and
a control unit for controlling that a size of a first data range scrolled according to a scroll input across a first length of a first region on the touch-screen is greater than a size of a second data range scrolled according to a scroll input across a first length of a second range, and controlling that a size of a third data range scrolled according to a scroll input across a first length starting from the first region and ending at the second region is a same as the size of the first data range.

18. The apparatus of claim 17, wherein the control unit determines the actual movement distance by a finger panning in real-time and displays the data by scrolling the same data in the proceeding direction when a scroll input by the finger panning is produced on the touch panel.
